(19) United States
(12) Patent Application Publication
(10) Pub. No.: US 2024/0269883 A1
(43) Pub. Date: Aug. 15, 2024

(54) PROCESS FOR MANUFACTURING A STRAW-BASED MATERIAL

(71) Applicants: Serge DESTRÉMAU, SAINTES (FR); Célyne DESTRÉMAU, MONTIGNY-SUR-LOING (FR)

(72) Inventors: Serge DESTRÉMAU, SAINTES (FR); Célyne DESTRÉMAU, MONTIGNY-SUR-LOING (FR)

(21) Appl. No.: 18/290,706

(22) PCT Filed: Jul. 21, 2022
(86) PCT No.: PCT/IB22/56724

§ 371 Date: Jan. 19, 2024

(30) Foreign Application Priority Data
Jul. 21, 2021 (FR) FR2107839

(51) Int. Cl. B27N 1/02; B27N 3/00; B27N 3/28

(52) U.S. Cl. CPC B27N 1/02; B27N 3/002; B27N 3/28

(57) ABSTRACT

The invention relates to a process for manufacturing a straw-based material, wherein: a) the straw is carded, b) straw wool is recovered first, and straw powder second, c) at least said straw powder is wetted, and d) at least the wetted straw powder is dried.

The present invention relates to the field of manufacturing eco-friendly materials, intended in particular, but not exclusively, for the fields of building construction, industry, textiles, trades.

The search for eco-friendly materials, especially for building construction, has been the subject of constant research efforts for many years.

Thus, for example, there has been an interest in the possibility of using straw for the thermal and sound insulation of buildings in particular with wooden frameworks.

For the purposes of the present patent application, “straw” means the part of the stalk of a cereal or grass comprised between the stubble (plant base) and the ear (plant end).

The use of this straw is of great interest from both an environmental and an economic point of view.

Indeed, out of the 25 million tons of straw produced annually in France, around 7 million remain in the field, and a study by INRAE (French National Research Institute for Agriculture, Food and the Environment) has shown that out of these 7 million, around 4 million tons could be harvested without agronomic harm.

Conventionally, straw in the construction sector is compressed into bales which, in order to comply with the thermal and sound insulation regulations in force, must have a thickness of around 37 cm, which is very restrictive.

In addition, these straw bales have a relatively high density of around 80 to 120 kg per cubic meter, which makes them difficult to handle.

For these reasons, research has been carried out on the use of straw wool, i.e. fibers resulting from straw carding.

This carding operation consists of mechanically deconstructing the straw strands, so as to transform them into fibers that, entangled with each other, form the straw wool.

French patent FR29900221 illustrates an example of the use of straw wool, with which a binder such as potato starch is incorporated, to obtain after drying a rigid material intended in particular for thermal and sound insulation.

With a density of around 40 kg per cubic meter and excellent thermal and sound insulation properties, straw wool, a material according to French patent FR29900221, therefore makes it possible to provide a substantial improvement compared to straw bales of the prior art.

The aim of the present invention is in particular that of substantially improving the process described in patent FR2900221.

This aim is achieved with a process for manufacturing a straw-based material, wherein:
a) the straw is carded,
b) straw wool is recovered first, and straw powder second,
c) at least said straw powder is wetted, and
d) at least the wetted straw powder is dried.

For the purposes of the present invention, the terms “straw wool” and “straw powder” respectively mean the fractions resulting from the carding of the straw typically having grain sizes respectively greater than and less than about 3 mm.

The straw powder essentially consists of lignin, which is a good binder when it is wetted and dried.

The process according to the invention therefore makes it possible to use a fraction of the carded straw—the straw powder—which can represent up to 50% by weight of this straw, whereas this powder is unused in the process according to patent FR2900221.

If only wetted and dried straw powder is used, insulating wall panels can be obtained that fulfill a similar function to conventional plasterboards used in the construction sector.

According to other optional features of the process according to the invention, taken alone or in combination:
said straw and/or straw wool are wetted before and/or during and/or after step a) or step b);
said straw powder is mixed with said straw wool after step b), and the product comprising said straw powder and said straw wool is dried: in this option, both straw powder and straw wool are used, which makes it possible to obtain blocks of materials having simultaneously an excellent shape stability, low density, and very good thermal and acoustic insulating properties;
a binder is mixed at least with said straw powder: such a binder makes it possible to improve the shape stability and cohesion of the material formed by the powder of this wetted and dried straw;
said binder is mixed with said straw powder and with said straw wool, and the product comprising said binder, said straw powder and said straw wool is dried;
in step b), said straw powder is separated from said straw wool by showering the straw carded during step a) on a conveyor sieve: it is thus possible, in a single operation, to carry out the wetting of the straw powder and the straw wool, as well as their mechanical separation;
one or more intermediate steps of drying said straw wool and/or said straw powder are performed;
shaping of said straw wool and/or said straw powder is performed by compression and/or thermocompression and/or casting and/or extrusion: the desired block or panel shapes can thus be obtained;
the product obtained in step c) is disposed between two protective sheets: these protective sheets protect the material obtained from impacts, and ensure its perfect shape stability when it is handled;
said straw is selected from the group comprising straw from wheat, rye, barley, oats, triticale, sunflower, or from Gramineae or Poaceae grasses selected from the group comprising: Aciachne, Acidosasa, Acostia, Acrachne, Acritochaete, Acroceras, Actinocladum, Aegilops, Aegilosecale, Aegilotricale, Aegilotriticum, Aegopogon, Aeluropus, Afrotrichloris, Agenium, Agrocalamagrostis, Agroelymus, Agrohordeum, Agropogon, Agropyron, Agropyropsis, Agrositanion, Agrostis, Agrotrisecale, Agrotriticum, Aira, Airopsis, Alloeochaete, Allolepis, Alloteropsis, Alopecurus, Alvimia, Ammochloa, Ammophila, Ampelodesmos, Amphicarpum, Amphipogon, Anadelphia, Ancistrachne, Ancistragrostis, Andropogon, Andropterum, Anisopogon, Anomochloa, Anthaenantiopsis, Anthenantia, Anthephora, Anthochloa, Anthoxanthum, Antinoria, Apera, Aphanelytrum, Apluda, Apochiton, Apoclada, Apocopis, Arberella, Arctagrostis, Arctodupontia, Arctophila, Aristida, Arrhenatherum, Arthragrostis, Arthraxon, Arthropogon, Arthrostylidium, Arundinaria, Arundinella, Arundo, Arundoclaytonia, Asthenochloa, Astrebla, Athroostachys, Atractantha, Aulonemia, Austrochloris, Austrofestuca, Avena, Axonopus, Bambusa, Baptorhachis, Beckmannia, Bewsia, Bhidea, Blepharidachne, Blepharoneuron, Boissiera, Bothriochloa, Bouteloua, Brachiaria, Brachyachne, Brachychloa, Brachyelytrum, Brachypodium, Briza, Bromofestuca, Bromuniola, Bromus, Brylkinia, Buchloe, Buchlomimus, Buergersiochloa, Calamagrostis, Calammophila, Calamovilfa, Calderonella, Calyptochloa, Capillipedium, Castellia, Catabrosa, Catalepis, Catapodium, Cathestecum, Cenchrus, Centotheca, Centrochloa, Centropodia, Chaetium, Chaetobromus, Chaetopoa, Chaetopogon, Chamaeraphis, Chandrasekharania, Chasmanthium, Chasmopodium, Chevalierella, Chikusichloa, Chimonobambusa, Chionachne, Chionochloa, Chloris, Chlorocalymma, Chondrosum, Chrysochloa, Chrysopogon, Chusquea, Cinna, Cladoraphis, Clausospicula, Cleistachne, Cleistochloa, Coelachne, Coelachyrum, Coelorachis, Coix, Colanthelia, Coleanthus, Colpodium, Cornucopiae, Cortaderia, Corynephorus, Cottea, Craspedorhachis, Crinipes, Crithopsis, Crypsis, Cryptochloa, Ctenium, Cutandia, Cyathopus, Cyclostachya, Cymbopogon, Cynochloris, Cynodon, Cynosurus, Cyperochloa, Cyphochlaena, Cyrtococcum, Dactylis, Dactyloctenium, Daknopholis, Danthonia, Danthonidium, Danthoniopsis, Dasypyrum, Decaryella, Decaryochloa, Dendrocalamus, Deschampsia, Desmazeria, Desmostachya, Diandrolyra, Diarrhena, Dichaetaria, Dichanthium, Dichelachne, Dielsiochloa, Digitaria, Dignathia, Diheteropogon, Dilophotriche, Dimeria, Dinebra, Dinochloa, Diplopogon, Dissanthelium, Dissochondrus, Distichlis, Drake-Brockmania, Dregeochloa, Dryopoa, Dupontia, Duthiea, Eccoptocarpha, Echinaria, Echinochloa, Echinolaena, Echinopogon, Ectrosia, Ectrosiopsis, Ehrharta, Ekmanochloa, Eleusine, Elionurus, Elyhordeum, Elyleymus, Elymandra, Elymostachys, Elymotriticum, Elymus, Elysitanion, Elytrophorus, Elytrostachys, Enneapogon, Enteropogon, Entolasia, Entoplocamia,
Eragrostiella, Eragrostis, Eremitis, Eremocaulon, Eremochloa, Eremopoa, Eremopyrum, Eriachne, Erianthecium, Eriochloa, Eriochrysis, Erioneuron, Euclasta, Eulalia, Eulaliopsis, Eustachys, Euthryptochloa, Exotheca, Farrago, Festuca, Festulolium, Festulpia, Fingerhuthia, Froesiochloa, Garnotia, Gastridium, Gaudinia, Germainia, Gigantochloa, Gilgiochloa, Glaziophyton, Glyceria, Glyphochloa, Gouinia, Graphephorum, Greslania, Griffithsochloa, Guaduella, Gymnopogon, Gynerium, Habrochloa, Hackelochloa, Hainardia, Hainardiopholis, Hakonechloa, Halopyrum, Harpachne, Harpochloa, Helictotrichon, Hemarthria, Hemisorghum, Henrardia, Heterachne, Heteranthelium, Heteranthoecia, Heteropholis, Heteropogon, Hickelia, Hierochloe, Hilaria, Hitchcockella, Holcolemma, Holcus, Homolepis, Homopholis, Homozeugos, Hordale, Hordelymus, Hordeum, Hubbardia, Hubbardochloa, Humbertochloa, Hydrothauma, Hygrochloa, Hygroryza, Hylebates, Hymenachne, Hyparrhenia, Hyperthelia, Hypseochloa, Hystrix“I” Ichnanthus, Imperata, Indocalamus, Indopoa, Indosasa, Isachne, Ischaemum, Iseilema, Ixophorus, Jansenella, Jouvea, Kampochloa, Kaokochloa, Kengia, Kerriochloa, Koeleria, Lagurus, Lamarckia, Lamprothyrsus, Lasiacis, Lasiurus, Lecomtella, Leersia, Leptagrostis, Leptaspis, Leptocarydion, Leptochloa, Leptocoryphium, Leptothrium, Lepturidium, Lepturopetium, Lepturus, Leymopyron, Leymostachys, Leymotrix, Leymus, Libyella, Limnas, Limnodea, Limnopoa, Lindbergella, Lintonia, Lithachne, Littledalea, Loliolum, Lolium, Lophacme, Lophatherum, Lopholepis, Lophopogon, Loudetia, Loudetiopsis, Louisiella, Loxodera, Luziola, Lycochloa, Lycurus, Lygeum, Maclurolyra, Maltebrunia, Manisuris, Megalachne, Megaloprotachne, Megastachya, Melanocenchris, Melica, Melinis, Melocalamus, Melocanna, Merostachys, Mesosetum, Metcalfia, Mibora, Micraira, Microbriza, Microcalamus, Microchloa, Micropyropsis, Micropyrum, Microstegium, Milium, Miscanthus, Mnesithea, Mniochloa, Molinia, Monachather, Monanthochloe, Monelytrum, Monocymbium, Monodia, Mosdenia, Muhlenbergia, Munroa, Myriocladus, Myriostachya, Narduroides, Nardus, Nassella, Nastus, Neesiochloa, Nematopoa, Neobouteloua, Neostapfia, Neostapfiella, Nephelochloa, Neurachne, Neurolepis, Neuropoa, Neyraudia, Notochloe, Ochlandra, Ochthochloa, Odontelytrum, Odyssea, Olmeca, Olyra, Ophiuros, Opizia, Oplismenopsis, Oplismenus, Orcuttia, Oreobambos, Oreochloa, Orinus, Oropetium, Ortachne, Orthoclada, Oryticum, Oryza, Oryzidium, Oryzopsis, Otachyrium, Ottochloa, Oxychloris, Oxyrhachis, Oxytenanthera, Panicum, Pappophorum, Paractaenum, Parafestuca, Parahyparrhenia, Paraneurachne, Parapholis, Paratheria, Pariana, Parodiolyra, Paspalidium, Paspalum, Pennisetum, Pentameris, Pentapogon, Pentarrhaphis, Pentaschistis, Pereilema, Periballia, Perotis, Perrierbambus, Peyritschia, Phacelurus, Phaenanthoecium, Phaenosperma,
Phalaris, Pharus, Pheidochloa, Phippsia, Phleum, Pholiurus, Phragmites, Phyllorachis, Phyllostachys, Piptochaetium, Piptophyllum, Piresia, Plagiantha, Plagiosetum, Plectrachne, Pleuropogon, Plinthanthesis, Poa, Poagrostis, Podophorus, Poecilostachys, Pogonachne, Pogonarthria, Pogonatherum, Pogonochloa, Pogononeura, Pohlidium, Polevansia, Polypogon, Polytoca, Polytrias, Pommereulla, Porteresia, Potamophila, Pringleochloa, Prionanthium, Prosphytochloa, Psammagrostis, Psammochloa, Psathyrostachys, Pseudanthistiria, Pseudechinolaena, Pseudochaetochloa, Pseudocoix, Pseudodanthonia, Pseudodichanthium, Pseudopentameris, Pseudoraphis, Pseudosasa, Pseudosorghum, Pseudozoysia, Psilolemma, Psilurus, Puccinellia, Pucciphippsia, Puelia, Pyrrhanthera, Racemobambos, Raddia, Raddiella, Ratzeburgia, Redfieldia, Reederochloa, Rehia, Reimarochloa, Reitzia, Relchela, Reynaudia, Rhipidocladum, Rhizocephalus, Rhombolytrum, Rhynchoryza, Rhytachne, Richardsiella, Rostraria, Rottboellia, Rytidosperma, Saccharum, Sacciolepis, Sartidia, Sasa, Schaffnerella, Schedonnardus, Schismus, Schizachne, Schizachyrium, Schizostachyum, Schmidtia, Schoenefeldia, Sclerachne, Sclerochloa, Sclerodactylon, Scleropogon, Scolochloa, Scribneria, Scutachne, Secale, Sehima, Semiarundinaria, Sesleria, Setaria, Setariopsis, Shibataea, Silentvalleya, Simplicia, Sinarundinaria, Sinobambusa, Sitanion, Sitordeum, Snowdenia, Soderstromia, Sohnsia, Sorghastrum, Sorghum, Spartina, Spartochloa, Spathia, Sphaerobambos, Sphaerocaryum, Spheneria, Sphenopholis, Sphenopus, Spinifex, Spodiopogon, Sporobolus, Steinchisma, Steirachne, Stenotaphrum, Stephanachne, Stereochlaena, Steyermarkochloa, Stipa, Stipagrostis, Stiporyzopsis, Streblochaete, Streptochaeta, Streptogyna, Streptolophus, Streptostachys, Styppeiochloa, Sucrea, Suddia, Swallenia, Symplectrodia, Taeniatherum, Tarigidia, Tatianyx, Tetrachaete, Tetrachne, Tetrapogon, Thamnocalamus, Thaumastochloa, Thelepogon, Themeda, Thrasya, Thrasyopsis, Thuarea, Thyridachne, Thyridolepis, Thyrsostachys, Thysanolaena, Torreyochloa, Tovarochloa, Trachypogon, Trachys, Tragus, Tribolium, Trichloris, Tricholaena, Trichoneura, Trichopteryx, Tridens, Trikeraia, Trilobachne, Triniochloa, Triodia, Triplachne, Triplasis, Triplopogon, Tripogon, Tripsacum, Triraphis, Triscenia, Trisetaria, Trisetokoeleria, Trisetum, Tristachya, Triticosecale, Triticum, Tritordeum, Tuctoria, Uniola, Uranthoecium, Urelytrum, Urochlaena, Urochloa, Urochondra, Vaseyochloa, Ventenata, Vetiveria, Vietnamosasa, Viguierella, Vossia, Vulpia, Vulpiella, Wangenheimia, Whiteochloa, Willkommia, Xerochloa, Yakirra, Yvesia, Zea, Zenkeria, Zeugites, Zingeria, Zizania, Zizaniopsis, Zonotriche, Zoysia, Zygochloa;
said binder is selected from the group comprising bio-sourced and/or organic and/or mineral binders;
said binder is selected from the group comprising:
starch from the group comprising wheat, rye, barley, maize, chestnut, horse chestnut, millet, rice, buckwheat, quinoa, spelt, soya, pea, potato, cassava flours,
sugars, algae, fungi, casein, tannin, lignin, cellulose, collagen,
plant resins selected from the group comprising conifers, Dracaenas, Burseraceae, cannabis,
latex selected from the group comprising Euphorbiaceae, Apocynaceae, Campanulaceae, Papaveraceae, Sapotaceae,
desiccant oil selected from the group comprising linseed oil, safflower oil, walnut oil, poppyseed oil,
gum arabic, egg, wax, beeswax,
minerals selected from the group comprising lime, clays, silica, silicon, alumina, magnesia,
hydrocarbon compounds selected from the group comprising asphalts and tars,
synthetic resins and polymers selected from the group comprising urea resins, urea-formaldehyde resins, melamine-urea-formaldehyde resins, phenol-formaldehyde resins, melamine-urea-phenol-formaldehyde resins, alkyd resins, acrylic resins, polyurethane resins, polyester resins, vinyl resins, polyethylenes, polypropylenes;
at least one adjuvant is associated with the product;
said adjuvant is selected from the group comprising bio-sourced and/or organic and/or mineral and/or synthetic and/or metallic adjuvants;
said adjuvant is selected from the group comprising:
feathers,
wools,
fibers obtained from cereals selected from the group comprising canola, sunflower, flax, soya, castor oil plant, peanut, sesame, cotton, sea kale, hemp,
wood fibers,
glass fibers,
carbon fibers,
metallic fibers,
polymers selected from the group comprising polystyrene, polyurethane, polyester,
plant extracts selected from the group comprising: Apricot (Prunus armeniaca), Absinthe (Artemisia absinthium L.), Bear's breeches (Acanthus mollis), Yarrow (Achillea millefolium L.), Aconite (Aconitum napellus subsp. napellus), Sweet flag (Acorus calamus), Pheasant's eye (Adonis vernalis), Motherwort (Leonurus cardiaca L.), Citrus fruits, Common agrimony (Agrimonia eupatoria L.), Cultivated garlic (Allium sativum), Victory onion (Allium victorialis), Bear's garlic, Bear's garlic (Allium ursinum L.), European blueberry (Vaccinium myrtillus L.), Lingonberry (Vaccinium vitis-idaea L.), Ajowan, Lady's mantle (Alchemilla vulgaris L.), Alpine lady's mantle (Alchemilla alpina), Garlic mustard (Alliaria officinalis), Cape Aloe (Aloe ferox), Almond (Amygdalus communis), Liverwort (Hepatica nobilis), Three-leaved anemone (Anemone trifolia), Meadow anemone (Anemone pulsatilla), Dill, Wild angelica (Angelica sylvestris L.), Norwegian angelica (Angelica archangelica), Anise (Green anise or Star anise), Silverweed (Potentilla anserina L.), not to be confused with the species (Chenopodium sp.), Stinking chamomile (Anthemis cotula), Kidney vetch (Anthyllis vulneraria), Strawberry tree (Arbutus unedo), Judas tree (Cercis siliquastrum), Birthwort (Aristolochia clematitis), Sweet wormwood (Artemisia annua), White wormwood (Artemisia alba), Mugwort (Artemisia vulgaris), Sea wormwood (Artemisia maritima), Mountain arnica (Arnica montana), Artichoke (Cynara scolymus), European wild ginger (Asarum europaeum), Asafoetida, Asparagus (Asparagus officinalis), Sweet woodruff, Sweet woodruff (Galium odoratum), White asphodel (Asphodelus albus), Hawthorn (medicinal component) (Crataegus laevigata and Crataegus monogyna), Grey alder (Alnus incana),
Black alder (Alnus glutinosa), Aurone, Cultivated oats (Avena sativa), Badiane, Badiane or Star anise (Illicium verum), Black horehound (Ballota foetida), Giant thorny bamboo (Bambusa arundinacea), Wintercress (Barbarea vulgaris), Basil, Sweet basil (Ocimum basilicum), Common stork's bill (Erodium cicutarium), Belladonna (Atropa belladonna), Wood avens (Geum urbanum), Bitter orange, Cornflower (Cyanus segetum or Centaurea cyanus), Great mullein (Verbascum thapsus), White or silver birch (Betula alba) and (Betula verrucosa), Borage (Borago officinalis), Shepherd's purse (Capsella bursa-pastoris), Heal-all (Prunella vulgaris), Heather: (Erica cinerea), Red bryony (Bryonia dioica), Bugleherb (Ajuga reptans), Common bugloss (Anchusa officinalis), Spiny restharrow (Ononis spinosa), Common box (Buxus sempervirens), Bearberry (Arctostaphylos uva-ursi), Large-flowered calamint (Calamintha grandiflora), Lesser calamint (Clinopodium nepeta. formerly Calamintha officinalis), Calluna (Calluna vulgaris), Roman chamomile (Anthemis nobilis), Ramping bellflower (Campanula rapunculus), Cinnamon, Southern maidenhair fern (Adiantum capillus-veneris), Maidenhair spleenwort (Asplenium trichomanes), Caper, Nasturtium, Cuckoo flower (Cardamine pratensis), Hairy bittercress (Cardamine hirsuta), Cardamom, Wild teasel (Dipsacus fullonum), Cardoon (Cynara cardunculus), Stemless carline thistle (Carlina acaulis), Carrot (Daucus sativus), Wild carrot (Daucus carota), Carob (Ceratonia siliqua), Caraway (Carum carvi), Blackcurrant (Ribes nigrum), Citron, Atlas cedar (Cedrus atlantica), Cedar of Lebanon (Cedrus libani), Celery (Apium graveolens), Purple star thistle (Centaurea calcitrapa), Brown knapweed (Centaurea jacea), Red valerian (Centranthus ruber), Giant chickweed (Myosoton aquaticum), Chervil (Anthriscus cerefolium), Sweet cicely, Cow parsley (Anthriscus sylvestris), Bird cherry (Cerasus padus), Rustyback fern (Ceterach officinarum), Hemp (Cannabis sativa L.), Slender thistle (Carduus tenuiflorus), Sweet chestnut (Castanea sativa), Greater celandine (Chelidonium majus), Sessile oak (Quercus petraea),
Chicory (Cichorium intybus), Common couch (Elymus repens or Agropyrum repens), Scallion, Chives, Lemon, Lemongrass, Quince (Cydonia vulgaris), Autumn crocus (Colchicum autumnale), Common comfrey or true comfrey (Symphytum officinale L.), Common poppy (Papaver rhoeas), Coriander (Coriandrum sativum), Field pumpkin (Curcubita pepo), Garden cress, Watercress, Cumin, Turmeric, Alfalfa dodder (Cuscuta epithymum), Mediterranean cypress (Cupressus sempervirens), Jimsonweed (Datura stramonium), Foxglove (Digitalis purpurea), Perennial wall rocket (Diplotaxis tenuifolia), White wall rocket (Diplotaxis erucoides), Black spleenwort (Asplenium adiantum-nigrum), Round-leaved sundew (Drosera rotundifolia), Shallot, Narrow-leaf coneflower (Echinacea angustifolia), Purple coneflower (Echinacea purpura), Dog-rose (Rosa canina), Ground elder (Aegopodium podagraria), Common hedgenettle (Betonica officinalis), Alpine Willowherb (Epilopium dodonaei), Hairy willowherb (Epilopium hirsutum), Hoary willowherb (Epilopium parviflorum), Fireweed (Chamerion angustifolium), Barberry (Berberis vulgaris), Field maple (Acer campestre), Tarragon, Eucalyptus (Eucalyptus globulus), Hemp-agrimony (Eupatorium cannabinum), Sun splurge (Euphorbia helioscopia), Eyebright (Euphrasia officinalis), False pepper, Fennel (Foeniculum Vulgare), Spignel (Meum athamanticum), Fenugreek, Sweet vernal grass (Anthoxantum odoratum), Male fern (Dryopteris filix-mas), Wild strawberry (Fragaria vesca), Raspberry (Rubus idaus), Common fumitory (Fumaria officinalis), European spindle (Euonymus europaeus), Galangal, Galega (Galega officinalis), Prickly juniper (Juniperus oxycedrus), Common juniper (Juniperus communis), Juniper, Great yellow gentian (Gentiana lutea), Ginger, Clove, Common wallflower (Erysimum cheiri), Blue gum (Eucalyptus globulus), Common nettle (Urtica dioica), Greater periwinkle (Vinca major), Great horsetail (Equisetum telmateia), Pomegranate (Punica granatum), Mistletoe (Viscum album), Marshmallow (Althaaea officinalis), Common hop (Humulus lupulus), Hyssop (Hyssopus officinalis), Common everlasting, Iris, Henbane (Hyoscyamus niger), Sand sedge (Carex arenaria), White dead-nettle or white nettle (Lamium album), Sweet bay, English lavender (Lavandula angustifolia), Common ivy (Hedera helix), Ground ivy (Glechoma hederacae), Common flax (Linum usitatissimum), Common toadflax (Linaria vulgaris), Lovage, Stag's-horn clubmoss (Lycopodium clavatum), Manuka (Leptospermum scoparium), Marjoram, European horse-chestnut (Aesculus hippocastanum), Wild mallow or common mallow (Malva sylvestris), Yellow sweet clover (Melilotus officinalis), Lemon balm (Melissa officinalis), Bastard balm (Melittis melissophyllum), Mint (Mentha), Bogbean (Menyanthes trifoliata), European nettle tree (Celtis australis), Yarrow (Achillea millefolium), Tutsan (Hypericum androsaemum), St. John's wort (Hypericum perforatum), Bee balm, White mustard, Indian mustard, Daisy-leaved toadflax (Anarrhinum bellidifolium),
Lily of the valley (Convallaria majalis), Nutmeg, Cultivated nigella, Hazel (Corylus L.), Onion, Onion (Allium cepa), Bitter orange, or Bigarade orange (Citrus aurantium), Oregano or Wild marjoram (Origanum vulgare), White dead-nettle (Lamium album), Field eryngo (Eryngium campestre), Sea holly (Eryngium maritimum), Common daisy (Bellis perennis), California poppy (Escholtzia californica), Opium poppy (Papaver somniferum), Wild pansy (Viola tricolore), Parsley, Common centaury (Centaurium erythraea), Fool's parsley (Aethusa cynapium), Common periwinkle (Vinca minor), Chinese lantern (Physalis alkekengi), Mountain everlasting (Antennaria dioica), Allspice, Pimentos, Salad burnet, Dandelions (Taraxacum sp.), Cyprus turpentine (Pistacia terebinthus L.), Common water plantain (Alisma plantago-aquatica), Ribwort plantain (Plantago lanceolata), Leek, Many-flowered garlic (Allium polyanthum), Sichuan pepper, Grain of paradise, Brazilian pink pepper, Peruvian pink pepper, Silverweed (Potentilla anserina), Common tormentil (Potentilla erecta), Common purslane (Portulaca oleracea), Field horsetail (Equisetum arvense), Rough horsetail (Equisetum hyemale), Cowslip (Primula veris), Blackthorn (Prunus spinosa), Lungwort (Pulmonaria officinalis), Horseradish, Licorice (Glycyrrhiza glabra L.), Common knotgrass (Polygonum aviculare), Rosemary, Rosemary (Rosmarinus officinalis), Bramble (Rubus fructicosus), Rocket (Eruca sativa), Sea rocket (Cakile maritima), Achiote, Rue, Common rue (Ruta graveolens), Lady's-slipper orchid (Cypripedium calceolus), Saffron, Silver fir (Abies alba), Savory, Summer savory (Satureja hortensis) and Winter savory (Satureja montana), Sassafras, Sage, Common sage (Salvia officinalis), Solomon's seal (Polodorantum odoratum), Hart's tongue fern (Asplenium scolopendrium), Sesame, Hedge mustard (Sisymbrium officinale), Purple nutsedge (Cyperus rotundus), Field marigold (Calendula arvensis), Pot marigold (Calendula officinalis), Red sandspurry (Arenaria rubra), Sumac, Black elder (Sambucus nigra), Tamarind, Tansey, Common tansey (Tanacetum vulgare), Thyme, Common thyme (Thymus vulgaris), Creeping thyme (Thymus serpyllum), Large-leaved lime (Tilia platyphyllos), Small-leaved lime (Tilia cordata), Silver linden (Tilia tomantosa), Coltsfoot (Tussilago farfara), Valerian (Valeriana officinalis), Vanilla, European goldenrod (Solidago virgaurea), Horseweed (Erigeron canadensis), Birdeye speedwell (Veronica persica), Germander speedwell (Veronica chamaedrys), Lemon verbena (Aloysia citrodora), Lemon beebrush, Common verbena (Verbena officinale), Red vine (Vitis sp.), Boston ivy (Ampelopsis veitchii), Sweet violet (Viola odorata);
during or after step c), the product undergoes a sealing treatment;
said treatment is carried out by submerging in a bath and/or coating and/or frying and/or spraying and/or wrapping and/or covering;
as a sealing agent, an agent selected from the group comprising the following is used:
fats, waxes, paraffins obtained from plants selected from the group comprising linseed, sunflower, palm, safflower, walnut, poppyseed,
fats, waxes, paraffins of animal origin,
synthetic fats, waxes, paraffins,
natural latex, obtained from plants selected from the group comprising Euphorbiaceae, Apocynaceae, Campanulaceae, Papaveraceae, Sapotaceae,
synthetic latex,
minerals selected from the group comprising lime, clays, silica, silicon, alumina, magnesia,
hydrocarbon compounds selected from the group comprising asphalts and tars,
synthetic resins and polymers selected from the group comprising urea resins, urea-formaldehyde resins, melamine-urea-formaldehyde resins, phenol-formaldehyde resins, melamine-urea-phenol-formaldehyde resins, alkyd resins, acrylic resins, polyurethane resins, polyester resins, vinyl resins, polyethylenes, polypropylenes;
at least one additive is associated with the product, selected from the group comprising a fire retardant agent, an insecticidal agent, a disinfectant agent, a herbicidal agent, a rodent-repellent agent, an antibacterial agent;
the product obtained from step c) is associated, by gluing and/or attaching and/or welding, with a flexible or rigid and/or homogeneous and/or woven and/or meshed element, formed in a material selected from the group comprising composites, metal alloys, organic fibers, mineral fibers, synthetic fibers.

The present invention also relates to a straw-based material, obtained with a process according to that described hereinabove.

Other features and benefits of the invention will become apparent upon reading the following description, with reference to the appended FIGURE, which illustrates:

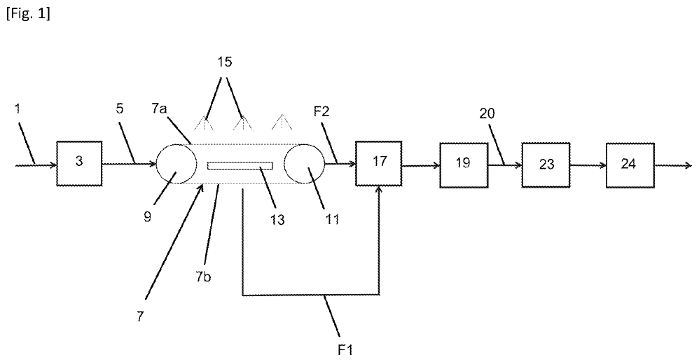

FIG. 1: schematically, the different steps of the process according to the invention.

Reference is now made to this FIGURE, where it can be seen that the harvested straw is discharged onto a first conveyor 1, in order to be fed into a carding machine 3.

This straw can be selected from the group defined in paragraph hereinabove.

Preferably, this straw is wetted with fresh and/or salt water and/or with steam before it is fed into the carding machine 3, and preferably with hot water: this makes it easier to carry out carding, as well as to eliminate bacteria.

Such a carding machine 3, known per se, comprises mechanical means such as nails mounted on circulating belts and/or abrasive disks, making it possible to deconstruct the straw strands, and to transform them into fibers and powder, the latter essentially consisting of straw lignin.

The straw thus carded is guided by a second conveyor 5 on a conveyor sieve 7 tensioned between two rollers 9, 11 of which at least one is driving.

This conveyor sieve may typically comprise a meshed conveyor belt, making it possible to separate the carded wool conveyed by the second conveyor 5 into two fractions, i.e., a fraction of grain size greater than 3 mm, remaining on the conveyor sieve, and a fraction of grain size less than 3 mm, passing through the meshes of this conveyor sieve 7.

These fractions of carded straw respectively constitute the straw wool and straw powder mentioned hereinabove.

The straw powder falls on a third conveyor belt 13 extending between the upper 7a and lower 7b strands of the conveyor sieve 7, and moving perpendicular thereto.

In order to facilitate the separation of the fine fraction of the carded straw, fresh water or salt water showers 15 spray the carded straw on the upper strand 7a of the conveyor sieve 7.

Advantageously, the water that has flowed on the conveyor belt 13 is collected in a tray located underneath the latter (not shown), then filtered in order to recover the suspended straw powder.

According to a first possible option (arrow F1), the straw powder thus wetted, from the conveyor belt 13 and/or the filtration, may be guided directly into a mixer 17, allowing the incorporation of one or more binders, one or more adjuvants, one or more additives according to paragraphs [0032], [0035], [0039] hereinabove, then the mixture thus obtained may pass into a system of molds or the like 19 making it possible to give this product the desired shape, in accordance with paragraph [0026] hereinabove.

The resulting product is conveyed by a fourth conveyor 20 into a drying zone 23, comprising means for producing hot air.

The product thus obtained may then undergo various treatments, such as a sealing treatment 24, in accordance with paragraph [0038] hereinabove.

According to a second possible option (arrow F2), the wetted straw wool from the upper strand 7a of the conveyor sieve 7 is also guided into the mixer 17, where it thus joins the straw powder.

The resulting mixed product, optionally supplemented with binder(s), adjuvant(s), additive(s), then undergoes the same steps of forming, drying, and optionally sealing as those mentioned hereinabove.

The first option mentioned hereinabove makes it possible to obtain an insulating material typically in the form of panels, for fulfilling a wall cladding function, similar to plasterboards marketed in particular under the Placoplâtre® brand.

The second option mentioned hereinabove makes it possible to obtain an insulating material typically in the form of blocks, for producing walls and partitions in the construction of buildings in particular with wooden frameworks.

The process according to the invention makes it possible to use the straw powder, which represents up to 50% by weight of the carded straw, and which fulfills a binder function, very advantageously.

When this binder function is not sufficient, one or more binders, of which the non-exhaustive list has been provided in paragraph hereinabove, may be added.

In addition, the adjuvants and additives proposed make it possible to impart to the panels and blocks obtained with the process according to the invention different characteristics meeting defined specifications: resistance to fire, pests, moisture, etc.

These panels and blocks may be used alone, or may be mounted on other flexible or rigid elements, as stated in paragraph hereinabove.

In addition to the drying step 23 mentioned hereinabove, intermediate drying steps may also be envisaged.

The process described hereinabove makes it possible to obtain a lightweight material with excellent thermal and sound insulation properties: a block of such a material with a thickness of about 25 cm makes it possible to obtain equally good results as a conventional block of straw with a greater thickness.

This very eco-friendly process makes it possible to use all the components of the grain or grass straw optimally, in particular the powder resulting from carding, which is very rich in lignin.

This process is even more advantageous when the straw is obtained from organic farming, as the straw strands may then be significantly longer than those from conventional farming: typically 70 cm versus 25 cm.

In addition, this process has the advantage that it can be implemented by conventional machines, already used for manufacturing glass wool, on one hand, and plasterboards, on the other.

However, it should be noted that, unlike the manufacture of glass wool, the process according to the invention does not require any significant temperature rise, which makes it very energy-efficient.

Of course, the invention is described above by way of example. It is understood that a person skilled in the art is capable of creating various alternative embodiments of the invention without for all that leaving the scope of the invention.

What is claimed is:

1. Process for manufacturing a straw-based material, wherein:
a) the straw is carded,
b) straw wool is recovered first, and straw powder second,
c) at least said straw powder is wetted, and
d) at least the wetted straw powder is dried.

2. Process according to claim 1, wherein said straw and/or straw wool are wetted before and/or during and/or after step a) or step b).

3. Process according to claim 1, wherein said straw powder is mixed with said straw wool after step b), and the product comprising said straw powder and said straw wool is dried.

4. Process according to claim 1, wherein a binder is mixed at least with said straw powder.

5. Process according to claim 3, wherein said binder is mixed with said straw powder and with said straw wool, and the product comprising said binder, said straw powder and said straw wool is dried.

6. Process according to claim 1, wherein, in step b), said straw powder is separated from said straw wool by showering the straw carded during step a) on a conveyor sieve.

7. Process according to claim 1, wherein one or more intermediate steps of drying said straw wool and/or said straw powder are performed.

8. Process according to claim 1, wherein shaping of said straw wool and/or said straw powder is performed by compression and/or thermocompression and/or casting and/or extrusion.

9. Process according to claim 1, wherein the product obtained in step c) is disposed between two protective sheets.

10. Process according to claim 1, wherein said straw is selected from the group comprising straw from wheat, rye, barley, oats, triticale, sunflower, or from Gramineae or Poaceae grasses.

11. Process according to claim 4, wherein said binder is selected from the group comprising bio-sourced and/or organic and/or mineral binders.

12. Process according to claim 11, wherein said binder is selected from the group comprising: starch, sugars, plant resins, latex, desiccant oil, gum arabic, minerals, hydrocarbon compounds, synthetic resins and polymers.

13. Process according to claim 1, wherein at least one adjuvant is combined with said straw powder or the mixture of straw powder and straw wool.

14. Process according to claim 13, wherein said adjuvant is selected from the group comprising bio-sourced and/or organic and/or mineral and/or synthetic and/or metallic adjuvants.

15. Process according to claim 14, wherein said adjuvant is selected from the group comprising:
feathers,
wools,
fibers obtained from cereals selected from the group comprising canola, sunflower, flax, soya, castor oil plant, peanut, sesame, cotton, sea kale, hemp,
wood fibers,
glass fibers,
carbon fibers,
metallic fibers,
polymers selected from the group comprising polystyrene, polyurethane, polyester,
plant extracts.

16. Process according to a claim 1, wherein, during or after step c), the product undergoes a sealing treatment.

17. Process according to claim 16, wherein said treatment is carried out by submerging in a bath and/or coating and/or frying and/or spraying and/or wrapping and/or covering.

17. Process according to claim 16, wherein, as a sealing agent, an agent selected from the group comprising the following is used: fats obtained from plants, fats of animal origin, synthetic fats, natural latex, synthetic latex, minerals, hydrocarbon compounds, synthetic resins and polymers.

19. Process according to claim 1, wherein at least one additive is associated with said straw powder or the mixture of straw powder and straw wool, selected from the group comprising a fire retardant agent, an insecticidal agent, a disinfectant agent, a herbicidal agent, a rodent-repellent agent, an antibacterial agent.

20. Process according to claim 1, wherein the product obtained from step c) is associated, by gluing and/or attaching and/or welding, with a flexible or rigid and/or homogeneous and/or woven and/or meshed element, formed in a material selected from the group comprising composites, metal alloys, organic fibers, mineral fibers, synthetic fibers.

21. (canceled)
